(19) United States
(12) Patent Application Publication
(10) Pub. No.: US 2022/0250874 A1
(43) Pub. Date: Aug. 11, 2022

(54) MONITORING OF AN ELEVATOR SYSTEM

(71) Applicant: KONE CORPORATION, Helsinki (FI)

(72) Inventors: Petteri Valjus, Helsinki (FI); Henri Wenlin, Helsinki (FI); Timo Lamminmäki, Helsinki (FI)

(73) Assignee: KONE CORPORATION, Helsinki (FI)

(21) Appl. No.: 17/712,467

(22) Filed: Apr. 4, 2022

Related U.S. Application Data
(63) Continuation of application No. PCT/FI2019/050846, filed on Nov. 27, 2019.

(51) Int. Cl. B66B 7/12

(52) U.S. Cl. CPC B66B 7/123

(57) ABSTRACT

An arrangement for monitoring an elevator, including at least one elevator rope and an entity along which the at least one elevator rope is arranged to travel at least in part, includes at least one inductive sensor positioned so that a magnetic field generable by the at least one inductive sensor extends at least in part over the at least one elevator rope; and a control device for obtaining measurement data from the inductive sensor. A method for monitoring the elevator, a computer program product and an elevator system are also disclosed.

### TECHNICAL FIELD

The invention concerns in general the technical field of elevators. More particularly, the invention concerns a monitoring solution for an elevator.

### BACKGROUND

Roped elevator systems are based on a solution in which an elevator car is raised and lowered by elevator ropes, typically made of metal. The elevator ropes, such as hoisting ropes or overspeed governor ropes, are attached to the elevator car at one end and to a weight at the other end and the elevator rope is looped at least partly around a traction sheave, or any similar entity, between the mentioned ends. For example, the traction sheave is a grooved pulley into which grooves the traction rope, or ropes, is fitted to. Moreover, the traction sheave is coupled to an electrical motor, and when the motor is controlled to turn the traction sheaves rotates, and as a result the elevator car moves along its pathway e.g. in an elevator shaft. Corresponding entities to the traction sheave along which the elevator rope may travel may e.g. be diverter pulleys.

An essential requirement for use of elevators is safety. Hence, there is need to monitor wearing parts of the elevator system. For example, the elevator ropes and traction sheave are wearing parts having an estimated life-time and for this reason a condition of the elevator ropes and the traction sheave needs to be monitored for ensuring safe use of the elevator system and life-time predictability in question.

Typically, the elevator ropes used in the elevator solutions now-a-days are stranded steel wire ropes. The ropes may be affected by corrosion, chemical attack as well as mechanical attack which all may cause damages to the ropes. Similarly, the traction sheave made of metal and possibly coated with some applicable material, such as rubber, polyurethane or some other elastic material, may be affected the similar attacks as the elevator ropes, and in addition the grooves of the traction sheave may wear out e.g. so that their shape changes and as a result, the elevator rope in question may penetrate deeper in the groove of the traction sheave in question. In addition to the traction sheave similar affection may occur in diverter pulleys along which the elevator rope(s) are arranged to travel at least in part.

There has been introduced some solutions for monitoring a condition of the elevator ropes and a condition of the traction sheave, which are based on optical sensing. In other words, some sort of light source, such as a laser light source, with a sensor is applied to monitor the mentioned targets. However, some challenges have been faced due to reflection of the light from the environment, but also due to a fact that the application environment is dirty and dusty requiring special attention in the implementation of the light source and the sensor.

Hence, there is a need to develop more sophisticated approaches for monitoring of a condition of at least some entities of the elevator for improving safety.

### SUMMARY

The following presents a simplified summary in order to provide basic understanding of some aspects of various invention embodiments. The summary is not an extensive overview of the invention. It is neither intended to identify key or critical elements of the invention nor to delineate the scope of the invention. The following summary merely presents some concepts of the invention in a simplified form as a prelude to a more detailed description of exemplifying embodiments of the invention.

An object of the invention is to present an arrangement, a method, a computer program product and an elevator system for monitoring an elevator.

The objects of the invention are reached by an arrangement, a method, a computer program product and an elevator system for monitoring an elevator as defined by the respective independent claims.

According to a first aspect, an arrangement for monitoring an elevator is provided, the elevator comprising at least one elevator rope and an entity along which the at least one elevator rope is arranged to travel at least in part, the arrangement comprises: at least one inductive sensor positioned so that a magnetic field generable by the at least one inductive sensor extends at least in part over the at least one elevator rope; and a control device for obtaining measurement data from the inductive sensor.

The arrangement may also comprise a support structure for mounting the at least one inductive sensor with respect to the at least one elevator rope so that the magnetic field generable by the at least one inductive sensor extends at least in part over the at least one elevator rope. For example, the support structure may be mounted to a framework of the entity along which the at least one elevator rope is arranged to travel at least in part.

Moreover, the at least one inductive sensor may be mounted so that the magnetic field generable by the at least one inductive sensor extends at least in part over the at least one elevator rope within a length the at least one elevator rope interacts with the entity along which the at least one elevator rope is arranged to travel at least in part.

The control device may be arranged to determine a change in the measurement data by comparing at least one value of the measurement data to a respective at least one value of a reference data. For example, the control device may be arranged to determine the change in a distance between the at least one inductive sensor (150) and the at least one elevator rope (110) in the comparison. Alternatively or in addition, the control device may be arranged to determine a changed portion of the measurement data with respect to the reference data. For example, the control device may be arranged to determine a type of the change by comparing the changed portion to at least one predetermined pattern stored in data storage accessible to the control device, the at least one predetermined pattern being indicative to the type of change.

Still further, the entity along which the at least one elevator rope may be arranged to travel at least in part is one of: a traction sheave, a diverter pulley. The diverter pulley may e.g. be arranged to at least one of the following: in an elevator car; in an elevator shaft.

According to a second aspect, a method for monitoring an elevator is provided the elevator comprising at least one elevator rope and an entity along which the at least one elevator rope is arranged to travel at least in part, the method comprises: receiving, by a control device, a measurement data from at least one inductive sensor positioned so that a magnetic field generable by the at least one inductive sensor extends at least in part over the at least one elevator rope; comparing at least one value of the measurement data to a respective at least one value of a reference data; setting, in accordance with a comparison between the at least one value of the measurement data to the respective at least one value of a reference data, a detection result to express one of the following: (i) an operation of the elevator is proper, (ii) an operation of the elevator is not improper.

The method may further comprise: determining a distance between the inductive sensor and the at least one elevator rope from the measurement data as the at least one value for comparison.

According to a third aspect, a computer program product for monitoring an elevator is provided, the elevator comprising at least one elevator rope and an entity along which the at least one elevator rope is arranged to travel at least in part which, when executed by at least one processor, cause a control device to perform the method in accordance with the second aspect.

According to a fourth aspect, an elevator system is provided, the elevator system comprising: at least one elevator rope; an entity along which the at least one elevator rope is arranged to travel at least in part; an arrangement in accordance with the first aspect.

The expression “a number of” refers herein to any positive integer starting from one, e.g. to one, two, or three.

The expression “a plurality of” refers herein to any positive integer starting from two, e.g. to two, three, or four.

Various exemplifying and non-limiting embodiments of the invention both as to constructions and to methods of operation, together with additional objects and advantages thereof, will be best understood from the following description of specific exemplifying and non-limiting embodiments when read in connection with the accompanying drawings.

The verbs “to comprise” and “to include” are used in this document as open limitations that neither exclude nor require the existence of unrecited features. The features recited in dependent claims are mutually freely combinable unless otherwise explicitly stated. Furthermore, it is to be understood that the use of “a” or “an”, i.e. a singular form, throughout this document does not exclude a plurality.

### BRIEF DESCRIPTION OF FIGURES

The embodiments of the invention are illustrated by way of example, and not by way of limitation, in the figures of the accompanying drawings.

FIG. 1 illustrates schematically an example of an arrangement according to an example embodiment.

FIGS. 2A and 2B illustrate schematically some aspects of a positioning of a sensor in the arrangement according to some example embodiments.

FIG. 3 illustrates schematically an example of a method according to an example embodiment.

FIG. 4 illustrates schematically another example of an arrangement according to an example embodiment.

FIG. 5 illustrates schematically a control unit according to an example embodiment.

### DESCRIPTION OF THE EXEMPLIFYING EMBODIMENTS

The specific examples provided in the description given below should not be construed as limiting the scope and/or the applicability of the appended claims. Lists and groups of examples provided in the description given below are not exhaustive unless otherwise explicitly stated.

Some aspects of the present invention may be described by introducing an arrangement for monitoring at least some aspects of an elevator. The monitoring may be directed to one or more entities along which an elevator rope is arranged to travel at least in part along its path. Moreover, the monitoring of the mentioned entities may relate to a monitoring of a condition of the entity indirectly through a monitoring of the elevator rope in a manner as is described in the forthcoming description. In addition to the monitoring of the condition of the entity along which an elevator rope is arranged to travel at least in part along its path the condition of the elevator rope may also be monitored. Here the elevator rope may refer to a hoisting rope or overspeed governor rope e.g. used for one or more suspension or traction or safety gear operation. The entity along which the elevator rope may travel at least in part may e.g. be a traction sheave or a diverter pulley also covering e.g. an overspeed governor pulley. Moreover, in some example embodiment the diverter pulley may be arranged to travel together with an elevator car or fixedly mounted in an elevator shaft to guide the elevator rope, such as the hoisting rope or the overspeed governor rope, therein. In order to generate data for performing the monitoring at least one inductive sensor may be arranged with respect to the entity along which the elevator rope in question is arranged to travel at least in part so that a magnetic field generable by the inductive sensor may extend at least in part over the monitored target, such as the entity and/or the elevator rope. A control device may be arranged to obtain the measurement data from the at least one inductive sensor and to perform an analysis based on the measurement data obtainable from the at least one inductive sensor.

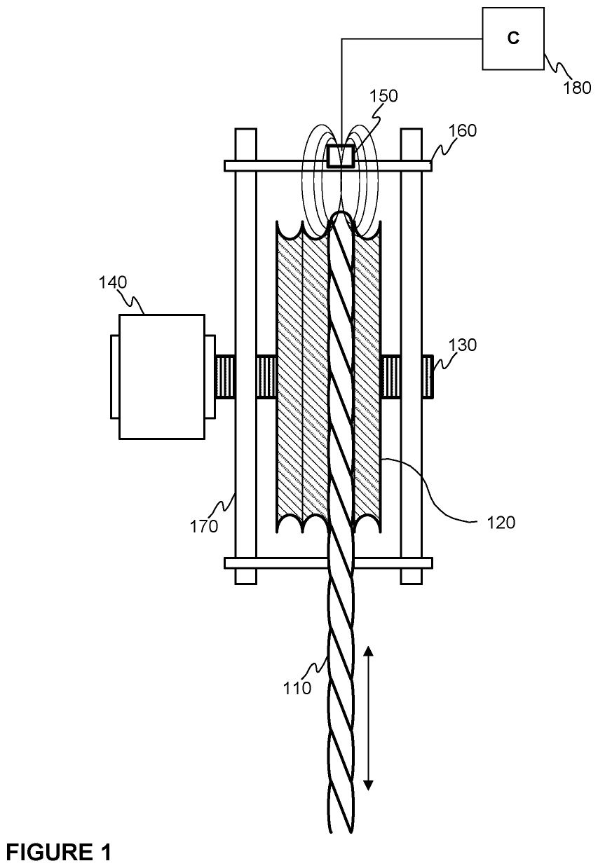

Next, an arrangement of the present invention is described by referring to FIG. 1. In the FIG. 1 the arrangement according to an example embodiment is disclosed in a context of traction system. In the traction system at least one elevator rope 110 is arranged to travel at least in part along an entity 120 called a traction sheave. The traction sheave may be coupled to a drive shaft 130 providing a rotational force to the traction sheave in order to move the elevator car coupled to the elevator rope 110. The rotational force provided to the drive shaft 130 is generated by an electrical drive comprising an electrical motor among other entities. As mentioned, the arrangement according to example embodiments of the present invention comprises at least one inductive sensor 150 which is arranged so that it may generate a magnetic field so that the magnetic field extends at least in part over the at least one elevator rope 110. In other words, the at least one inductive sensor 150 may be positioned accordingly e.g. by mounting it to a support structure 160, such as a jig arm. The support structure 160 may further be mounted to a framework 170 of the traction system arranged substantially stationary with respect to the object under monitoring i.e. the at least one elevator rope 110. Still further, the arrangement may comprise a control device 180 which may obtain measurement data from the at least one sensor device 150. As said, in some other non-limiting example the at least one inductive sensor 150 may be positioned in a corresponding manner if the elevator rope 110 is monitored in a position of a diverter pulley along which the elevator rope 110 may be arranged to travel at least in part. Still further, the communicative connection between the at least one inductive sensor 150 and the control device 180 may be implemented in a wired manner or in a wireless manner e.g. implementing a known short-range communication technique. The communicative connection may implement a predetermined protocol, such as TCP/IP protocol, CAN (Controller Area Network) protocol or any other applicable protocol. The arrangement may comprise further elements and entities not illustrated in FIG. 1, but the entities included in FIG. 1 allow describing aspects of the present invention.

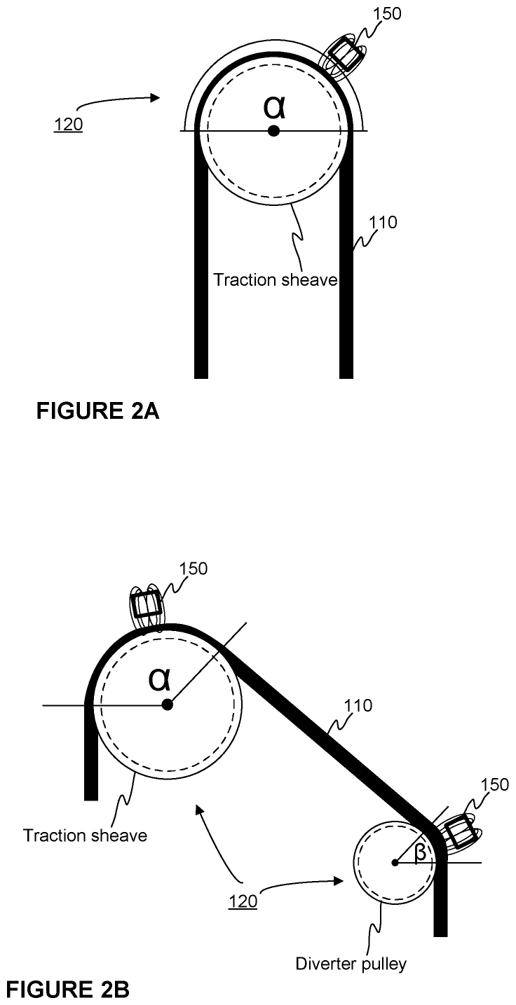

In accordance with example embodiments sources causing inaccuracy in the monitoring may advantageously be optimized. One source causing inaccuracy in the monitoring may be a vibration and/or an oscillation of the elevator rope 110 under monitoring during its operation. In order to optimize, or minimize, consequences of the vibration of the elevator rope 110 under monitoring the at least one inductive sensor 150 may advantageously be mounted so that the magnetic field generable by the at least one inductive sensor 150 extends at least in part over the at least one elevator rope 110 within a length the at least one elevator rope 110 interacts with the entity 120 along which the at least one elevator rope 110 is arranged to travel at least in part. The interaction may refer to a contact, such as directly, of the elevator rope 110 and the entity 120, such as the traction sheave or the diverter pulley, together. Then, the entity 120 supports the elevator rope 110 and dampens, at least in part, the vibration and/or the oscillation of the elevator rope 110 under monitoring. FIGS. 2A and 2B schematically illustrate some non-limiting examples of advantageous position of the at least one inductive sensor 150 with respect to some entities 120 along which the elevator rope 110 may travel at least in part. In FIG. 2A the entity 120 may be a traction sheave and an optimal position of the inductive sensor 150 is shown as an angle α which corresponds a sector in which the elevator rope 110 contacts a respective groove on an outer surface of the traction sheave. One inductive sensor 150 is illustrated in an example position with the sector in FIG. 2A. In another non-limiting example of FIG. 2B the elevator rope 110 is arranged to travel along two separate entities 120, which may be considered as a traction sheave and a diverter pulley. Correspondingly, the advantageous position for the inductive sensor to monitor the elevator rope 110 is shown as an angle α of the traction sheave and as an angle β of the diverter pulley. One inductive sensor 150 is illustrated in example positions within the sectors with respect to the traction sheave and the diverter pulley in FIG. 2B. As mentioned by positioning the at least one inductive sensor 150 in a measurement distance of at least part of the elevator rope 110 within the sectors defined by the angles α and/or β an effect of vibration of the elevator rope 110 especially during a drive of the elevator may be minimized, and, hence, an accuracy of the measurement may be improved.

Now, further aspects relating to a principle of monitoring at least one of the mentioned objects are now provided. An operating principle of an inductive sensor 150 is that by inputting an alternating current (AC current) in a coil of the inductive sensor 150 an alternating magnetic field is generated. Hence, the output signal of the inductive sensor 150 varies in accordance with the input current. Now, if a target being conductive, such as a metallic target, is brought in the magnetic field it changes the inductance of the coil of the inductive sensor 150 due to eddy current induced in the target. If the target moves in the magnetic field, the inductance changes along a motion of the target. Now, the arrangement according to example embodiments may be arranged to perform the monitoring so that the elevator rope 110 may reside at least in part in the magnetic field and generate the change in the inductance of the coil of the inductive sensor 150 e.g. in response to a motion within the magnetic field. By monitoring the inductance, and especially a change of it, at least one characteristic of the target under monitoring may be determined.

In order to establish the monitoring solution in accordance with the example embodiments a reference data may generated at a certain instant of time, such as when the elevator system, or at least parts involved are new. This may e.g. correspond to a situation that the elevator rope 110 and/or the entity 120, such as the traction sheave, are not damaged anyhow, such as worn out or got any shocks causing e.g. a change in surface pattern or shape of the entity in question. The same applies with respect to diverter pulley if it is under monitoring. Now, a test drive may e.g. be performed allowing the control device 180 to generate a reference data through receiving an output signal from the inductive sensor 150 along the length of the test drive. In other words, the moving parts, such as at least the elevator rope 110, cause a change in the inductance of the coil of the inductive sensor 150 which is represented in the output signal. The output signal may be generated as a position dependent i.e. the signal i.e. the inductance may be represented as a function of a position with respect to the elevator rope 110, for example. This kind of arrangement may allow defining an exact position of the elevator rope 110, and, hence, the value of inductance at the position in question. In some embodiments, the elevator rope 110 may be equipped with one or more reference tags, which may be detectable from the output signal of the inductive sensor 150 and, hence, allowing further data to determine the position of the elevator rope 110. As a result, a reference data may be generated, which in accordance with at least some example embodiments may be position dependent.

Still further, the monitoring of the elevator may be arranged to be performed continuously or at predefined intervals. The monitoring principle may be implemented so that every time the control device 180 receives the measurement data from the inductive sensor 150 the measurement data is compared to a corresponding reference data value. The corresponding reference data value may refer to a value representing the inductance at a certain position of the at least one elevator rope 110 in question. The comparison may generate an indication if the compared values deviate from each other over a predefined limit, such as more than 10%. According to some example embodiments in response to the detection that the deviation is more than the predefined limit, the indication may be generated. The indication may e.g. refer to a generation of an alarm signal to a respective entity, such as to a data centre monitoring one or more elevator systems.

In other words, for example in response to a use of the elevator there may occur a degradation in parts belonging to the elevator system. The degradation may e.g. refer to a worn-out of a groove of a traction sheave or a diverter pulley along which the elevator rope 110 under monitoring runs, or worn-out of the elevator rope 110 itself (e.g. a coating of the elevator rope 110). This kind of degradation causes a deviation (cf. increase) in distance of the elevator rope 110 from the inductive sensor 150. In practice the deviation in distance may be a consequence of that the elevator rope 110 penetrates deeper in the groove of the traction sheave or the diverter pulley or that the elevator rope 110 becomes thinner due to worn-out. The distance may e.g. be measured from a surface of the elevator rope 150 facing the inductive sensor 150. In other words, the deviation in distance may be detected from the measurement data obtained with the inductive sensor 150 e.g. by comparing it with measurement data of a previous state or with any other reference data e.g. determined by calculating it. For sake of clarity it is worthwhile to mention that with the arrangement as described it is also possible to detect if the distance between the at least one inductive sensor 150 and the elevator rope 110 under monitoring surprisingly decreases, which may e.g. be a consequence of a mispositioning of the entity 120 in question or that a shape of the elevator rope 110 has changed.

In some other example embodiments, based on the measurement data other representations of a target under monitoring may be established and used in comparison for determining a condition of the target. For example, a diameter or a shape of the elevator rope 110 (e.g. in cross-section) may be monitored or a surface pattern of the elevator rope 110. The deviations in the elevator rope 110 may e.g. be due to that one or more strands are loosened or even wire-cuts have occurred in the elevator rope 110. Moreover, the elevator rope 110 may have received an external shock causing the deviation is the shape of the elevator rope 110. Now, as a degraded entity moves in the magnetic field generated by the coil of the inductive sensor 150 the degraded point generates a value of the inductance of the coil which deviates from the value received from the test run or in any other corresponding manner. If the deviation exceeds the predefined limit, the indication may be generated as discussed in the foregoing description.

As mentioned, the reference data may be obtained from a test run. The term test run, and the reference data, shall be understood in a broad manner. It may be generated by using measurement data obtained from one or more earlier measurement instances. For example, it may be generated in statistical manner from measurement data of one or more earlier test runs. Alternatively or in addition, the reference data may be generated by computing the reference values mathematically e.g. based on the data representing the elevator system setup. Still further, the generation of the reference data may be based on a combination of performing one or more test runs and computing at least part of the reference data mathematically.

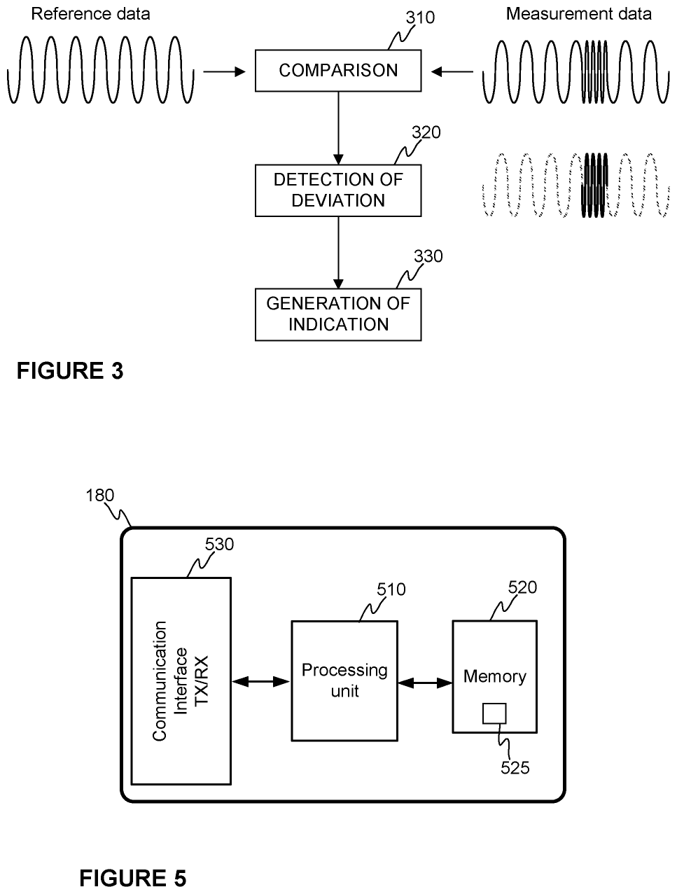

FIG. 3 illustrates schematically an example embodiment of a method performed for monitoring the elevator system. In FIG. 3 it is illustrated a signal form defined by a reference data e.g. obtained from the inductive sensor 150 when the monitoring arrangement is positioned with respect to at least one object under monitoring. The signal form defined by the reference signal schematically illustrated in FIG. 3 is a non-limiting example. The signal form may vary e.g. if the object under monitoring is moved within the magnetic field, but as said a reference signal is definable from the reference data obtainable from the inductive sensor 150 by the control device 180. In some example embodiments the reference data may refer to one or more values definable mathematically for an implementation in question, such as based on a setup of the arrangement. Furthermore, the measurement data may be obtained at one or more predefined instants of time. At least one value derivable from the measurement data may be compared 310 with a respective at least one value derivable from the reference data and the control device 180 may be arranged to detect 320 a deviation between the compared pieces of data. For example, a detection 320 may be based on identifying if a frequency of the output signal is changed or if an amplitude of the output signal is changed or if both changes are occurred. For sake of clarity it is worthwhile to mention that the output signal of the inductive sensor 150 may represent a voltage or a current and its variation e.g. in terms of frequency.

As referred in the foregoing description, one or more values representing one or more predefined parameters, such as a distance between the inductive sensor 150 and the elevator rope 110 under monitoring, may be defined from both the measurement data and the reference data and a deviation between the values may be detected 320 e.g. if the compared values deviate over a predefined limit. The detected deviation in the distance of the elevator rope 110 from the inductive sensor 150 may, thus, correspond to a worn out of at least one of: the entity 120 along which the elevator rope in question is arranged to travel at least in part, such as the groove of the traction sheave; the elevator rope 110. Alternatively, the at least one value defined from the measurement data may be compared to a respective comparison value defined e.g. mathematically. Such at least one comparison value shall be understood to correspond a reference data. In some example embodiments, for evaluating the deviation an acceptable deviation between the at least one value derivable from the measurement data and the respective at least one comparison value, such as at least one value derivable from the reference data or a predefined comparison value may be defined, wherein the acceptable deviation may be set such as 10%.

Next some further aspects with respect to the detection of the deviation are provided. For example, in some example embodiments the detection of deviation may comprise an analysis in which the at least one deviated value or a deviated portion of the output signal is analysed. In accordance with the example embodiments at least one goal of the analysis may be a capability to identify a type of degradation occurred to the object in question. The identification of the type of the degradation may be based on predefined patterns or data values stored in data storage accessible to the control device 180. In other words, the data storage may store a plurality of values, or definitions, for different kinds of degradations possible to be experienced by the at least one object under monitoring. Now, by comparing one or more values definable from the output signal with the one or more corresponding values in the reference data stored in the data storage the type of degradation causing the deviation may be identified. The fundamental consideration behind the identification is that different kinds of degradations generate different kinds of deviation to the output signal compared to reference data. As a non-limiting example, it may be considered that if the groove of the traction sheave in which the elevator rope 110 is arranged to travel at least in part wears out causing a deviation (i.e. increase) in a distance of the elevator rope 110 from the inductive sensor 150, it may be detected as a permanent change of the output signal of the inductive sensor 150, such as a decrease in the amplitude of the output signal of the inductive sensor 150, based on which the distance, or a deviation in distance, may be determined. On the other hand, if the elevator rope 110 is elongated along at least a part of its length, the elongation may again be detected based on a change of the output signal of the inductive sensor 150, such as based on a changed on deviated frequency of the output signal over a predetermined period of time. Still further, if the elevator rope 110 has experienced an external shock and its shape deviates only at one physical location, it may cause a short but rapid deviation in the output signal of the inductive sensor 150, such as in a frequency in the output signal of the inductive sensor 150. The non-limiting examples given in the foregoing description are for providing insight how different kinds of degradations may be identified based on a form of the output signal expressing the deviation in the at least one target under monitoring. As derivable from above the comparison may be performed on a basis of one or more parameters, such as a value presenting the mentioned distance, derivable from the reference data and the measurement data. Alternatively or in addition, the comparison and, hence, a detection of deviation, may be based on a comparison of values defining at least part of the output signal representing e.g. the deviated portion between the reference data and the measurement data. In various example embodiments an acceptable deviation between the at least one value derivable from the measurement data and the respective at least one value derivable from the reference data may be defined, such as 10%. Hence, it may be arranged that if the deviation is less that the allowed deviation, no actions are taken.

In response to a comparison, and especially in response to a detection of a deviation, a detection result, or indication, may be set 330. In other words, if a deviation is detected in step 320, an indication expressing the deviation may be generated 330 as the detection result. The detection result indicating the deviation may be understood to correspond to an outcome that the operation of the elevator is improper. The generation of the indication 330 may refer to a generation of a signal expressing an outcome of the detection to some extent. For example, in a simple case the outcome of the detection may be an indication that the detection has occurred. In some other example embodiment, the indication may provide information on the deviation itself, such as providing information on a type of change detected. Moreover, in a sophisticated solution according to an example embodiment the control device 180 may be arranged to include further information, such as information indicating a position of the deviation in the monitored entity, such as in the elevator rope 110 and/or in the entity 120 under monitoring. Depending on an implementation of the present invention, a detection result may also be set for indicating that no deviation is detected corresponding to an outcome that the operation of the elevator is proper.

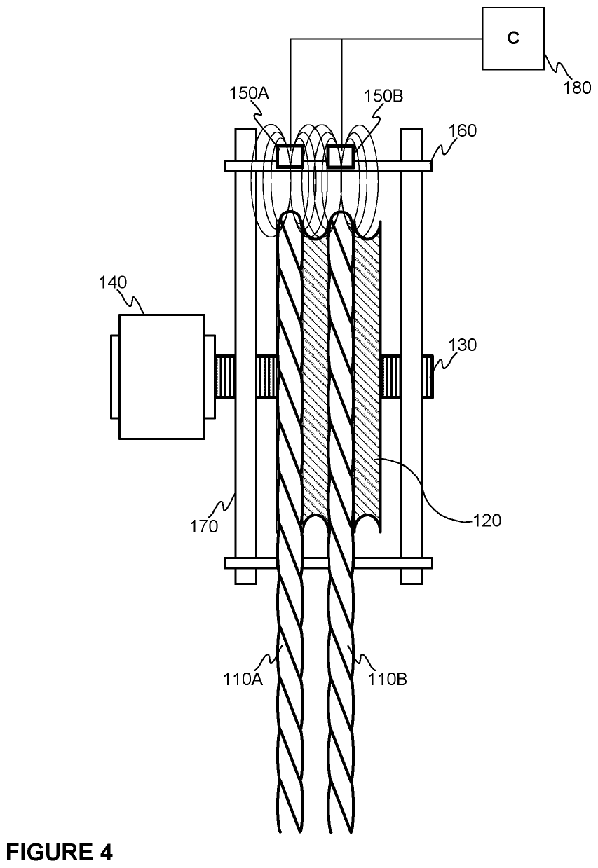

In some application environments there is need to monitor a plurality of targets, such as elevator ropes 110, of the elevator system simultaneously. Such an implementation is shown in FIG. 4. There two elevator ropes 110A, 1108 are arranged to travel over respective grooves of the traction sheave. In order to monitor a condition of both elevator ropes 110A, 1108 but also possibly one or more characteristics of the respective entity 120, such as grooves of the traction sheave, a respective inductive sensors 150A, 1508 are arranged to the generate output signal representing the sub-systems of the traction system under monitoring. The control device 180 may obtain the measurement data from the respective inductive sensors 150A, 1508 and to perform the method for both the measurement data e.g. in the manner as described. Still further, the reference data used in the analysis may be generated individually for both the sub-systems of the traction system.

For sake of completeness it is worthwhile to mention that in some example embodiments, especially those, in which the measurement data is obtained from an elevator system during a motion the output data from the inductive sensor 150 represents a slice-wise view of the objects under monitoring. The control device 180 may be arranged to establish a representation of the at least one object under monitoring over the length of the motion. For example, if the monitored object is only the elevator rope 110, a representation of the elevator rope 110 along the length of motion may be generated. The generated representation may be compared to a reference data, which may e.g. be a corresponding representation of the elevator rope 110, and if deviation between the two representations may be detected, the control device 180 may be arranged to operate in the described manner by generating an indication.

FIG. 5 schematically illustrates a control device 180 according to an example embodiment of the invention. The control unit 180 may comprise a processing unit 510, a memory 520 and a communication interface 530 among other entities. The processing unit 510, in turn, may comprise one or more processors arranged to implement one or more tasks for implementing at least part of the method steps as described. For example, the processing unit 510 may be arranged to control an operation of at least one inductive sensor 150, and even an operation of the traction system and/or the elevator system, as well as any other entities relating to the present invention. The memory 520 may be arranged to store computer program code as a non-transitory computer readable medium which, when executed by the processing unit 510, cause the control unit 180 to operate as described. Moreover, the memory 520 may be arranged to store, as described, the reference data, and any other data, such as a plurality of definitions for different kinds of degradations to be applied in the manner as described in the foregoing description. The communication interface 530 may be arranged to implement, e.g. under control of the processing unit 510, one or more communication protocols enabling the communication with the entities as described. The communication interface may comprise necessary hardware and software components for enabling e.g. wireless communication and/or communication in a wired manner.

The various example embodiments discussed herein are based at least on an impact a metallic target, such as at least one elevator rope 110 made of steel, to an output signal of at least one inductive sensor 150 positioned so that a magnetic field generable by the at least one inductive sensor 150 extends at least in part over a volume of the monitored target, such as the elevator rope 110. The change in inductance due to the metallic target, and especially due its motion within the magnetic field, may be detected from the output signal of the inductive sensor 150 and, hence, by evaluating the output signal, and especially its changes compared to reference data, a degradation, or any other deviation, in the monitored target and/or in any other entity derivable from the output data of the inductive sensor 150 may be detected. The outcome of the evaluation may be used in a decision-making if e.g. repair is needed in at least some parts of the elevator system or not. In this manner, a safety may be improved in the elevator systems. Moreover, the invention as described may be applied to during a normal use of an elevator system and, thus, no any kind of test drives is required unless desired.

The specific examples provided in the description given above should not be construed as limiting the applicability and/or the interpretation of the appended claims. Lists and groups of examples provided in the description given above are not exhaustive unless otherwise explicitly stated.

1. An arrangement for monitoring an elevator comprising at least one elevator rope and an entity along which the at least one elevator rope is arranged to travel at least in part, the arrangement comprising:
at least one inductive sensor positioned so that a magnetic field generable by the at least one inductive sensor extends at least in part over the at least one elevator rope; and
a control device for obtaining measurement data from the at least one inductive sensor.

2. The arrangement of claim 1, wherein the arrangement comprises a support structure for mounting the at least one inductive sensor with respect to the at least one elevator rope so that the magnetic field generable by the at least one inductive sensor extends at least in part over the at least one elevator rope.

3. The arrangement of claim 2, wherein the support structure is mounted to a framework of the entity along which the at least one elevator rope is arranged to travel at least in part.

4. The arrangement of claim 1, wherein the at least one inductive sensor is mounted so that the magnetic field generable by the at least one inductive sensor extends at least in part over the at least one elevator rope within a length the at least one elevator rope interacts with the entity along which the at least one elevator rope is arranged to travel at least in part.

5. The arrangement of claim 1, wherein the control device is arranged to determine a change in the measurement data by comparing at least one value of the measurement data to a respective at least one value of a reference data.

6. The arrangement of claim 5, wherein the control device is arranged to determine the change in a distance between the at least one inductive sensor and the at least one elevator rope in the comparison.

7. The arrangement of claim 5, wherein the control device is arranged to determine a changed portion of the measurement data with respect to the reference data.

8. The arrangement of claim 7, wherein the control device is arranged to determine a type of the change by comparing the changed portion to at least one predetermined pattern stored in data storage accessible to the control device, the at least one predetermined pattern being indicative to the type of change.

9. The arrangement of claim 1, wherein the entity along which the at least one elevator rope is arranged to travel at least in part is one of: a traction sheave and a diverter pulley.

10. The arrangement of claim 9, wherein the entity along which the at least one elevator rope is arranged to travel at least in part is a diverter puller, and wherein the diverter pulley is arranged to at least one of the following: in an elevator car; and in an elevator shaft.

11. A method for monitoring an elevator comprising at least one elevator rope and an entity along which the at least one elevator rope is arranged to travel at least in part, the method comprising:
receiving, by a control device measurement data from at least one inductive sensor positioned so that a magnetic field generable by the at least one inductive sensor extends at least in part over the at least one elevator rope;
comparing at least one value of the measurement data to a respective at least one value of a reference data; and
setting, in accordance with the comparison between the at least one value of the measurement data to the respective at least one value of a reference data, a detection result to express one of the following: an operation of the elevator is proper, and an operation of the elevator is improper.

12. The method of claim 11, further comprising:
determining a distance between the inductive sensor and the at least one elevator rope from the measurement data as the at least one value for comparison.

13. A computer program product embodied on a non-transitory computer readable medium for monitoring an elevator comprising at least one elevator rope and an entity along which the at least one elevator rope is arranged to travel at least in part, the computer program product, when executed by at least one processor, causes a control device to perform the method according to claim 10.

14. An elevator system, comprising:
at least one elevator rope;
an entity along which the at least one elevator rope is arranged to travel at least in part; and
the arrangement according to claim 1.

15. The arrangement of claim 2, wherein the at least one inductive sensor is mounted so that the magnetic field generable by the at least one inductive sensor extends at least in part over the at least one elevator rope within a length the at least one elevator rope interacts with the entity along which the at least one elevator rope is arranged to travel at least in part.

16. The arrangement of claim 3, wherein the at least one inductive sensor is mounted so that the magnetic field generable by the at least one inductive sensor extends at least in part over the at least one elevator rope within a length the at least one elevator rope interacts with the entity along which the at least one elevator rope is arranged to travel at least in part.

16. The arrangement of claim 2, wherein the control device is arranged to determine a change in the measurement data by comparing at least one value of the measurement data to a respective at least one value of a reference data.

17. The arrangement of claim 3, wherein the control device is arranged to determine a change in the measurement data by comparing at least one value of the measurement data to a respective at least one value of a reference data.

18. The arrangement of claim 4, wherein the control device is arranged to determine a change in the measurement data by comparing at least one value of the measurement data to a respective at least one value of a reference data.

19. The arrangement of claim 2, wherein the entity along which the at least one elevator rope is arranged to travel at least in part is one of: a traction sheave and a diverter pulley.

20. The arrangement of claim 3, wherein the entity along which the at least one elevator rope is arranged to travel at least in part is one of: a traction sheave and a diverter pulley.
